(19) United States
(12) Patent Application Publication
(10) Pub. No.: US 2005/0004731 A1
(43) Pub. Date: Jan. 6, 2005

(54) Drive-assist system

(76) Inventors: Jurgen Bohm, Oberneisen (DE); Joachim Nell, Hanau (DE); Georg Geduld, Eichberg (DE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/485,163

(22) PCT Filed: Jul. 26, 2002
(86) PCT No.: PCT/EP02/08365

(30) Foreign Application Priority Data
Aug. 1, 2001 (DE) 10137292.2

(51) Int. Cl. G06F 19/00

(52) U.S. Cl. 701/41; 701/301

(57) ABSTRACT

A driver-assist system on a motor vehicle with a servo-assisted steering systems, whereby environmental data for an instantaneous traffic situation are detected or estimated, instantaneous movement data of the vehicle are detected or estimated, and the detected or estimated environmental data are compared with the movement data of the vehicle and the zero point of the characteristic curve for the steering action is displaced according to said comparison.

### TECHNICAL FIELD

The present invention generally relates to driver assist systems and more particularly relates to driver-assist systems with a servo-assisted steering system.

### BACKGROUND OF THE INVENTION

The driver directs (or steers) the movement of the vehicle according to a desired course. If the driver is inattentive, the vehicle may deviate from its course. Several driver-assist systems are known which intervene directly with the steering of a vehicle.

DE 196 35 009 A1, for example, discloses a method for predicting a future vehicle behaviour or a future condition on the basis of the current vehicle condition and for influencing the steering force. Thus the driver shall be actively encouraged to move the vehicle on a predicted road lying ahead of it. Therefore, the driver is given information in the form of steering forces. The steering force (the moment of rotation of the steering wheel or the steering wheel actuation force) is increased in the predicted “right” direction and decreased in the opposite direction by changing the characteristics of the steering-assist system in such a way that a correcting value is added to an auxiliary force value in order to increase the steering force to the left or to the right.

However, the disadvantage of this system is that the steering does not respond in the way the driver is used to or wants it to, since the characteristics of the servo-assisted steering itself are changed. This might confuse the driver who does no longer control the vehicle completely due to the steering characteristics which he is not used to.

### BRIEF SUMMARY OF THE INVENTION

Therefore it is the object of the present invention to indicate a method and a device making it possible to maintain to a large extent the steering characteristics which the driver is used to and to assist him at the same time with his steering action.

The method includes the determination of a theoretical movement or theoretical course to be followed by the vehicle. For this reason, the environmental data for an instantaneous traffic situation are detected and/or estimated, a prediction of the future traffic situation is made on the basis of the environmental data and a theoretical movement or theoretical course based on the instantaneous and, if necessary, predicted traffic situation is determined. The term “environmental data of an instantaneous traffic situation” has to be broadly interpreted according to the present invention and includes all possible information which do not describe the vehicle or the driving situation itself, but the environment of the vehicle. Preferably, at least the course of the road is detected or estimated as environmental data.

Furthermore, the actual movement of the vehicle is determined. For this, the instantaneous movement data for the vehicle are detected or estimated. The term “movement data” includes all possible information describing the vehicle or the driving situation. Preferably, at least the vehicle course is detected or estimated as movement data.

After that, the theoretical movement or the theoretical course and the actual course or the actual movement are compared on the basis of a comparison of the detected or estimated environmental data with the movement data of the vehicle. The comparison can preferably be made in two ways:

On the one hand, a theoretical movement, which the vehicle has to follow in order to hold the theoretical course, can be determined on the basis of the theoretical course. Thus, according to the present invention a theoretical course and a theoretical course angle are determined on the basis of the detected or estimated course of the road and an actual course and an actual course angle are determined on the basis of the detected or estimated course of the vehicle. After that the theoretical movement (theoretical course and/or theoretical course angle) can be compared with the actual movement (actual course and/or actual course angle), the result of said comparison being a movement difference.

Another possibility consists in extrapolating an “actual” course from the actual movement which the vehicle would follow on the basis of the actual movement. After that the theoretical course and said actual course can be compared resulting in a course difference.

An essential fact for the present invention is that the result of the compared examination is used and the assistance of the steering action is changed according to this comparison by displacing the zero point of the characteristic curve for the steering action assistance according to the comparison. Displacing the zero point within the meaning of the present invention signifies a horizontal displacement of the boosting moment function which is mirror-symmetric as regards the straight travel against the steering moment applied by the driver without deviation of the boosting moment from the rule. Thus the driver receives an information for a movement of the steering action with regard to an adjustment of the vehicle course to the road course so that the usual “steering sensation” for a straight-ahead course is achieved at a certain angle position of the vehicle wheels. By means of the constant basic assist function the driver does not sense any change of the steering characteristics so that he is not made feeling insecure, receiving, however, a definite information on an advantageous steering wheel position. The driver is assisted with regard to a correction of the current actual course and/or actual course angle in the direction of the theoretical course and/or theoretical course angle. It has to be considered, however, that the determined theoretical course is not always the ideal course or the course which the driver wants to follow. Therefore, it is left to the discretion of the driver to use the information given to him in order to lead the vehicle onto the theoretical course or steer the vehicle on another course he wants to follow.

According to the present invention, the environmental data for the traffic situation are detected with at least one image-processing system, especially with suitable optical sensors, as infrared sensors or preferably a video camera. These devices detect, e.g., the road lines or a vehicle driving ahead, and transmit signals to an image processing device which determines the theoretical course, as e.g. the position co-ordinates with regard to the vehicle co-ordinates. In this connection, the theoretical course may be a position point, a sequence of points, a vector or a trajectory.

According to the present invention, the steering angle, the yaw speed or the lateral acceleration, i.e. the components around the vertical axis of the vehicle, or also appropriate components in the longitudinal direction of the vehicle are detected or estimated as movement data of the vehicle, preferably of the vehicle course. Thus the actual movement can depend on several parameters and/or include several components. Preferably the movement data for the vehicle are detected by at least one steering angle sensor sensing at least approximately the actual position of the steerable vehicle wheels. According to present invention, further values regarding the dynamics of the vehicle movement, especially the values of a dynamics control of an electronic brake control system (ESP system), are taken into consideration when changing the steering action assistance. Therefore, according to the present invention, sensors of an electronic dynamics control already existing in the vehicle are used in order to determine the actual movement.

According to the present invention, the current vehicle speed is also taken into consideration.

According to the present invention, the current steering action by the driver is determined or estimated and, if it is recognised that the driver has taken his hands off the steering wheel, there is no change of the steering action assistance.

According to the present invention a change in the steering action assistance is additionally assisted by a corresponding brake control, i.e. an additional control of at least one wheel brake. This is preferably the wheel brake on the vehicle's front axle since there the portion of the total braking of the vehicle amounts to about 70 or 80%. The brake pressure on the wheel brake is preferably increased in order to steer the vehicle to another direction, e.g. to the theoretical course. If the vehicle is already being braked, the brake pressure may also be increased on one wheel brake and reduced on the other wheel brake of the same axle. Preferably the brake pressure is reduced and at the same time increased in such a manner that the vehicle is not braked less than before.

The increase of the brake pressure may amount to less than 30 bar and the speed of the brake pressure increase (brake pressure gradient) may be in the range from 10 to 20 bar/s. The effect is that the driver senses only a small excursion of the vehicle and that the vehicle does not deviate considerably from its current course. Herewith the driver is only informed that he is leaving the determined theoretical course. However, the driver is still able to control the vehicle completely and to steer it as he desires.

If the driver is distracted and therefore leaves the theoretical course, it may be useful to put him on the alert. This may be done by an abrupt braking which may be achieved by a brake pressure gradient of more than 100 bar/s. Thereby the vehicle is shortly braked in a sharper way which is unpleasant for the driver so that he “wakes up” and pays attention to the driving process.

The present invention includes the possibility to operate an external pressure source by means of the brake control which generates a certain brake pressure irrespective of the brake request given by the driver by activating the brake pedal. The brake control preferably controls an electro-hydraulic brake.

The object is further achieved by a generic driver-assist system on a vehicle in which the means influencing the steering wheel assistance is provided with a means for displacing the zero point in order to displace the zero point of the characteristic curve for assisting the steering action according to said comparison.

According to the invention the driver-assist system includes a means for detecting the theoretical course in order to determine a theoretical course or a theoretical course angle on the basis of the detected or estimated course of the road, a means for sensing the actual course and the actual course angle on the basis of the detected or estimated vehicle course, a means for comparing the theoretical course and theoretical course angle with the actual course and the actual course angle, and the means for displacing the zero point shall be used for displacing the zero point of the characteristic curve for steering action assistance according to the comparison.

### BRIEF DESCRIPTION OF THE DRAWINGS

FIG. 1 is a schematic representation of a vehicle provided with a system for steering the vehicle with a driver-assist system according to the present invention.

FIG. 2 shows the geometrical values prevailing in case of lateral guidance or holding the course.

FIG. 3 shows a block diagram of the method for realising the steering-assist function.

FIG. 4 shows in detail the calculation of the additional steering-assist moment and the servo-assisted moment.

FIG. 5 shows resulting displacements of the characteristic curve of the servo-assisted steering for assisting the driver.

### DETAILED DESCRIPTION OF THE PREFERRED EMBODIMENTS

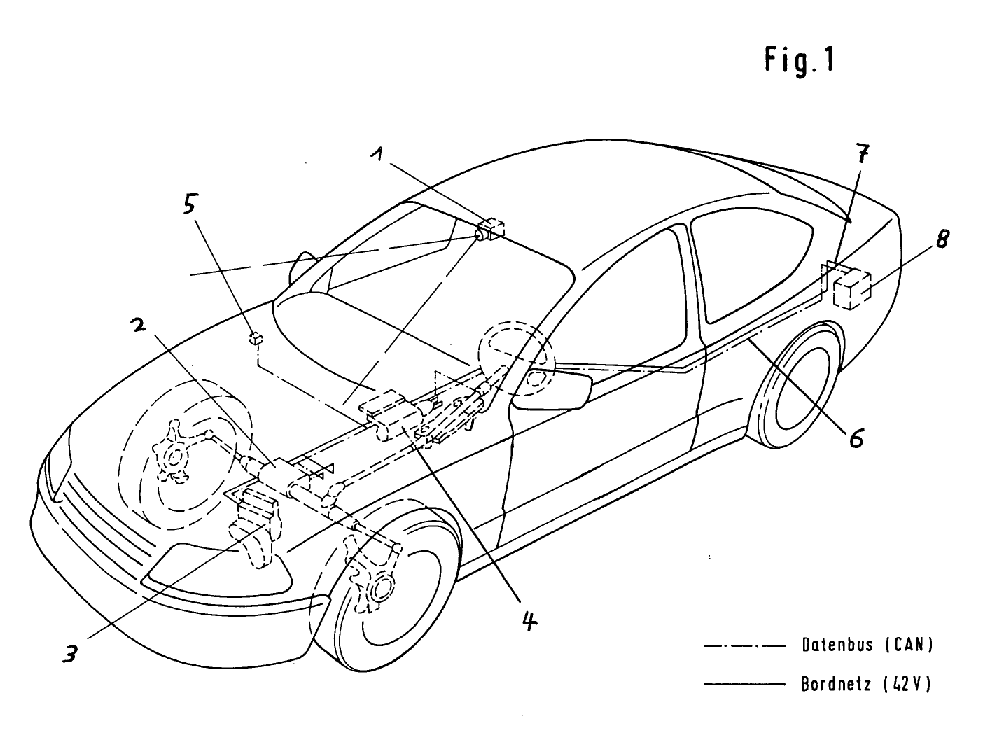

The essential components of the system shown in FIG. 1 include a CCD camera 1 for detecting the vehicle environment, especially the course of the driving track, an electrical servo-assisted steering (EPAS) 2, including a steering-assist function for the lateral guidance of the vehicle in addition to the basic function of the servo-assisted steering, as well as an electro-hydraulic brake system (EHB) 3 for realising braking interventions also irrespective of the driver. The EHB system offers the possibility to additionally realise distance controlling functions in a technically simple manner. The steering assistance and the brake system are controlled by a control unit 4. The control unit is connected to the driving motor of the vehicle by means of an interface in the engine compartment 5 and is able to receive signals from the motor control or send signals to it. The components are connected by means of a vehicle bus system, as e.g. CAN data bus (lines including dots and dashes 6) and are supplied with electrical current by means of a supply line 7. A vehicle battery 8 with a high electric voltage from 36 to 42 Volt serves as electrical current source. A high supply voltage is advantageous or even necessary (for big and heavy vehicles), especially for electrical actuators with high current consumption, as electric motors for a direct steering-assist function.

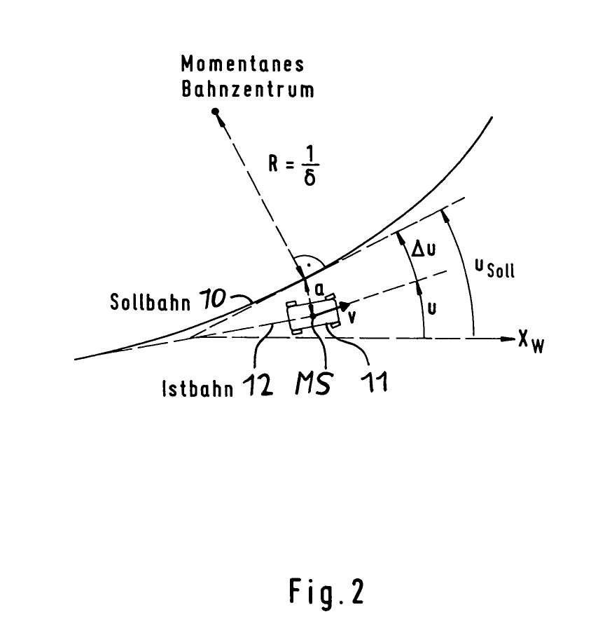

The geometrical quantities prevailing in case of lateral guidance and/or holding the course are represented in FIG. 2. The theoretical course 10 includes a current course radius R and/or course curve r=1/R. The vehicle 11 moves with a speed v on an actual course 12, the center of gravity MS being at a distance a from the theoretical course 10. The theoretical course angle defined by the currently detected theoretical course 10 is denominated uₜₕₑₒ, the actual course angle described by the vehicle is denominated u. The distance a as well as the angle of the course difference Δu=uₜₕₑₒ−u is minimised by means of the steering-assist function

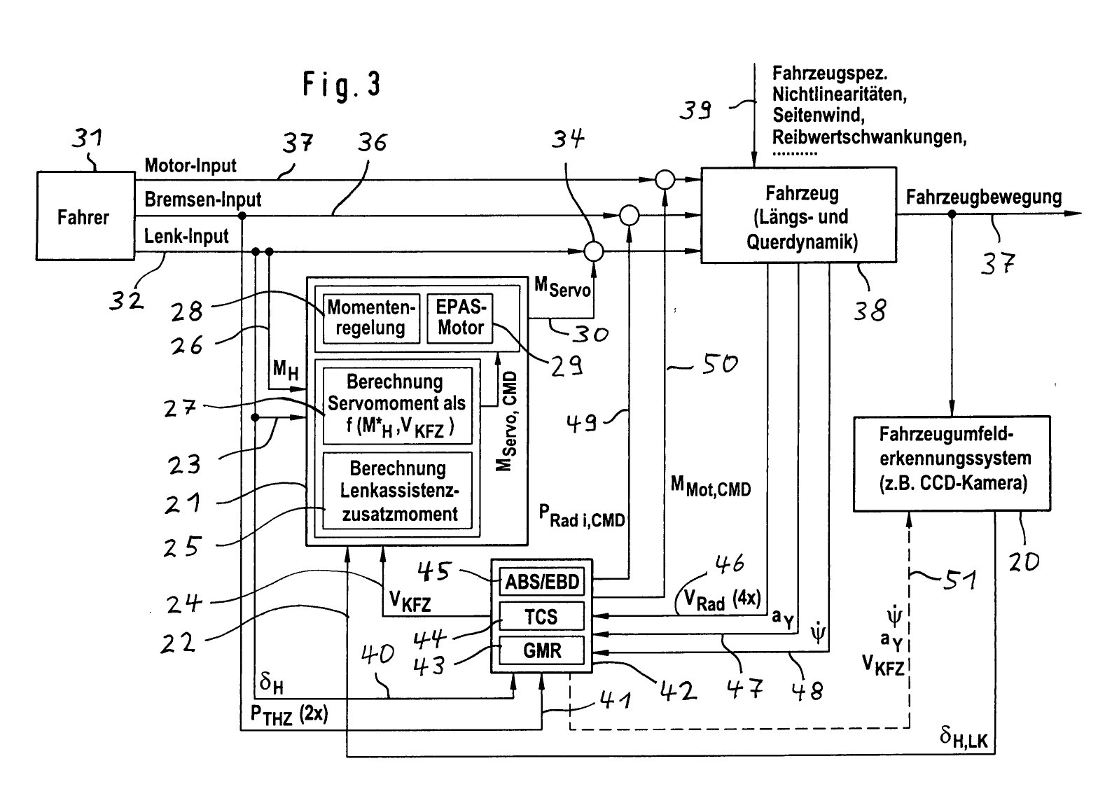

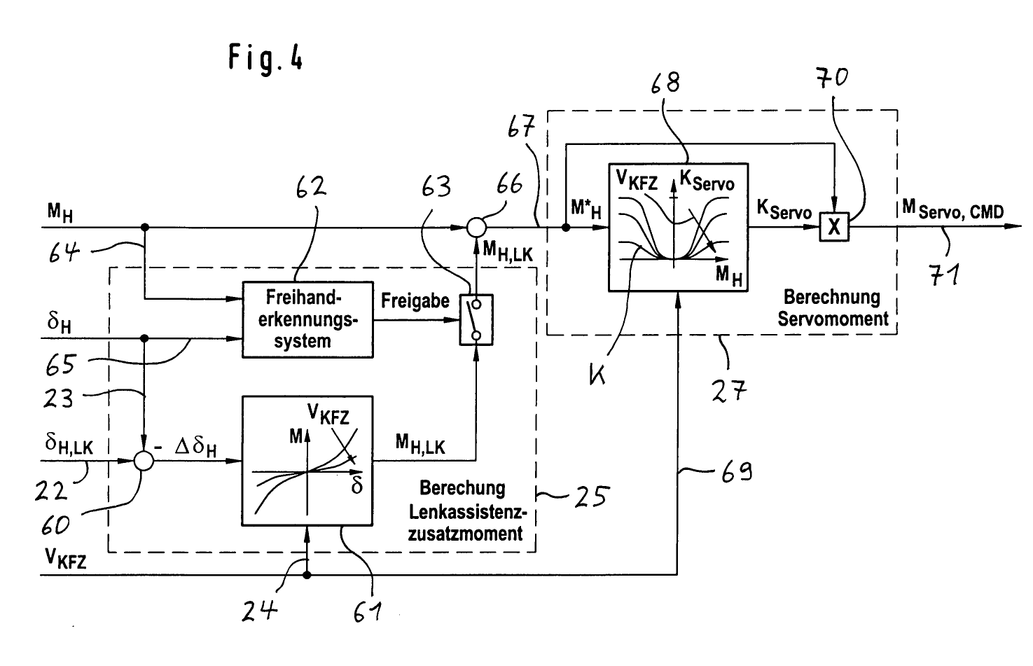

The block diagram for realising the steering-assist function in order to steer the course is represented in FIG. 3 and FIG. 4. The basic thought in this regard is that if a deviation from the theoretical course 10 is determined, the driver-assist system causes the driver by means of a (zero point) displacement of the characteristic curve of the steering booster and at the same time assists him to correct the current steering angle u and to move the steering wheel in the direction of the steering angle uₜₕₑₒ necessary for maintaining the course determined by the environment (road). This displacement corresponds also to a zero point displacement of the steering sensation when driving straight.

FIG. 3 shows that an image-processing system, a system for recognising the vehicle environment 20, as e.g. CCD camera 5 in FIG. 1, determines the environment of the vehicle, in particular the quantities a and Δu which have to be minimised, and determines, if necessary, a steering angle δ_{H, LK} to be set in order to maintain the course by means of further driving-dynamic quantities resulting from the driving process, the steering angle being transmitted 22 to the assist system 21. A further input quantity is the actual steering angle δ_{H} 23 set by the driver and the current vehicle speed Vᵥₑₕ 24. The assist system 21 defines an additional steering assist moment 25 resulting from the difference Δδ between the necessary steering angle δ_{H, LK} and the steering angle δ_{H} set by the driver, considering also the real vehicle speed Vᵥₑₕ. Thus, the additional steering assist moment represents an “adjusted” manual moment M_{H, LK} being superimposed on the manual moment M_{H} 26 applied by the driver on the steering wheel achieving an assistance for the driver and thus a zero point displacement. From this results a moment M*_{H}. Said resulting moment M*_{H} serves for calculating a servo-assisted moment 27 on the basis of the vehicle speed Vᵥₑₕ and is intensified to a servo-assisted moment M_{servo, CMD} considering the basic function of the servo-assisted steering. By means of the moment control 28 the servo-assisted steering motor 29 is operated according to the desired moment generating an assisting moment Mₛₑᵣᵥₒ 30 for the driver 31 in order to assist him 34 with his steering action 32. The vehicle dynamics 35 is influenced not only by the steering action 32 of the driver 31, but also by the brake application 36 and the driving motor 37 of the vehicle. Further influencing factors for the entire vehicle movement 38 are external conditions 39, as vehicle-specific non-linearities, side wind and variations of the friction value.

The steering angle δ_{H} 23 actually set by the driver 31 and the brake pressure P_{TMC} defined by the driver are transmitted to a brake control system 42 as input quantities 40, 41. Here, the brake control system 42 includes a yaw moment control 43, a drive slip control 44 and an anti-blocking system with electronic brake force distribution 45. Also the actual vehicle speed Vᵥₑₕ 24 is determined here. Wheel speed signals V_{wheel} 46, lateral acceleration signals 47 and yaw moment signals Ψ 48 are transmitted to the brake control system 45. The brake control system 45 generates output signals 49, 50 on the basis of the input signals 40, 41, 46, 47, 48 for influencing the brake pressure 49 and the motor control 50. The yaw moment signals Ψ, lateral acceleration signals a_{Y}, and vehicle speed Vᵥₑₕ are also transmitted 51 to the system 20 which recognises the vehicle environment.

FIG. 4 represents more in detail the calculation of the additional steering-assist moment 25 and the servo-assisted moment 27. The assistance system 21 determines an “adjusted” manual moment M_{H, LK} from the difference 60 between the necessary steering angle δ_{H, LK} 22 and the steering angle δ_{H} 23 set by the driver, taking into consideration the actual vehicle speed Vᵥₑₕ 24. The displacement of the characteristic curve of the servo-assisted steering is achieved in an advantageous manner only if it is guaranteed that the driver did not take his hands off the steering wheel. Thus, a hands-off recognition 62 releases 63 the determined additional moment M_{H, LK} only if it is recognised that the driver holds the steering wheel in his hands. This is recognised by means of small, low-frequency vibrations of the steering moment signal M_{H} 64 caused by continuous minimal corrections of the vehicle course by the driver. On the basis of the steering wheel angle δ_{H} which has also been sensed, the hands-off recognition 65 is additionally ensured and examined 65.

The manual moment M_{H} 26 applied by the driver onto the steering wheel is superimposed in an additive manner on the (released) additional moment M_{H, LK} in order to assist the driver. This results in a moment M*_{H} 67. From said resulting moment M*_{H} a certain characteristic curve K is determined considering the basic function 68 of the servo-assisted steering and the vehicle speed Vᵥₑₕ 69. On the basis of the desired servo-assistance Kservo and the resulting moment M*H the servo-assisted moment M_{servo, CMD} 71 is determined 70 by which the steering action of the driver is assisted by means of the moment control 28 of the electric motor of the servo-assisted steering.

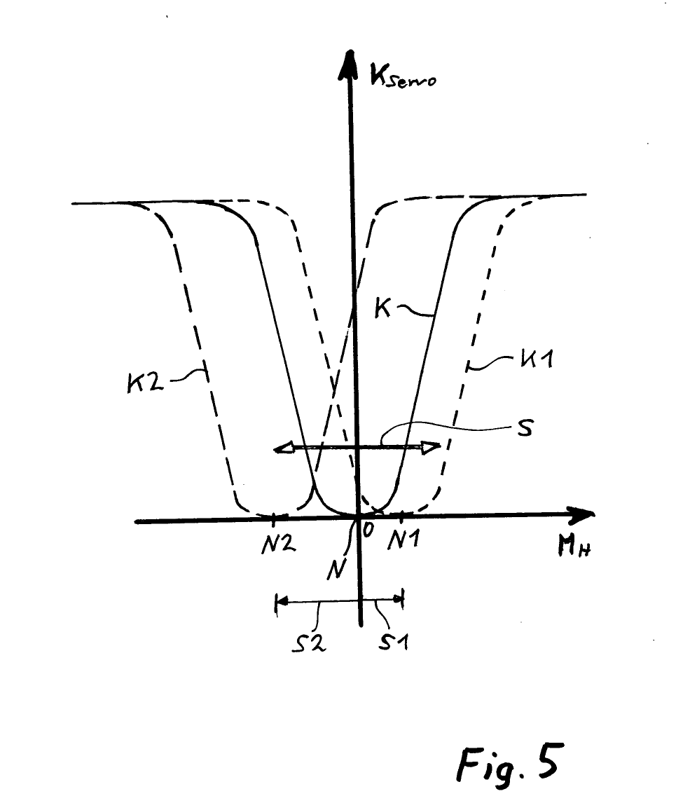

The displacement of the characteristic curve resulting from the superimposition of the manual moment M_{H} applied on the steering wheel by the driver with the additional moment M_{H, LK} is represented in FIG. 5. FIG. 5 shows the characteristic curve for the servo-assistance K, K1, K2 for three different driving situations. Without the assistance function the driver gets the assistance by characteristic curve K. The characteristic curve is a mirror-symmetrical function with regard to the straight-ahead position of the wheels (straight travel of the vehicle, zero point N). Increasing the manual steering moment M_{H} increases also the servo-assistance according to characteristic curve K so that the driver has to apply minor forces for the steering action.

According to the present invention the driver is assisted in his steering action and informed about an adjustment of the vehicle course to the road course by displacing the zero point accordingly (arrow S) in horizontal direction (on the axis of the manual moment M_{H}) (arrow S). If the driver has to turn the steering wheel (more) to the right, the characteristic curve is displaced to the right. Thus the “zero position” of the steering wheel, characterising a straight-ahead position of the wheels, is achieved in case of a certain position of the steerable vehicle wheels to the right. This is represented by the characteristic curve K1 with a zero point displaced by S1. A situation with a displacement S2 of the characteristic curve K to the left is shown by characteristic line K2. The servo-assisted steering function as such remains unaltered for all driving situations, so that the usual driving sensation is maintained for the driver. He therefore is not made insecure but nonetheless he receives a clear message regarding the proper steering wheel position.

1-12. (canceled)

13. Method for operating a driver-assist system on a vehicle, with a servo-assisted steering, comprising the steps of:
detecting or estimating the environmental data of an instantaneous traffic situation,
detecting or estimating instantaneous movement data of the vehicle, and
comparing environmental data with the movement data, wherein a zero point of a characteristic curve for steering action assistance is displaced according to said comparison.

14. Method according to claim 13, wherein at least the road course is detected or estimated as environmental data.

15. Method according to claim 13, wherein at least one vehicle course is detected or estimated as environmental data.

16. Method according to claim 13, wherein the environmental data are detected by at least one image-processing system.

17. Method according to claim 13, wherein the movement data of the vehicle are detected at least with a steering angle sensor detecting at least approximately an actual position of the steerable vehicle wheels.

18. Method according to claim 13, wherein the actual vehicle speed is part of said instantaneous movement data of said vehicle.

19. Method according to claim 13, the method further including the step of:
detecting or estimating at least one vehicle course as environmental data, wherein a theoretical course or an angle of the theoretical course is determined by the detected or estimated road course,
determining an actual course or an angle of the actual course on the basis of the detected or estimated vehicle course, wherein the theoretical course or the theoretical course angle is compared with the actual course or the actual course angle and the driver is assisted in correcting the current actual course or the actual course angle in the direction of the theoretical course or theoretical course angle.

20. Method according to claim 13, wherein driving-dynamic quantities is taken into consideration when changing the assistance of the steering action.

21. Method according to claim 13, wherein the actual steering action by the driver is determined or estimated and if it is determined that the driver had taken his hands off the steering wheel, the assistance of the steering action is not changed.

22. Method according to claim 13, wherein the change of the steering assistance includes brake control assistance.

23. Driver-assist system on a vehicle, with a servo-assisted steering, comprising:
means for detecting or estimating environmental data of an instantaneous traffic situation,
means for detecting or estimating instantaneous movement data of the vehicle,
means for comparing the detected or estimated environmental data with the movement data of the vehicle, and
means for influencing the steering assistance for changing a steering action which can be actuated by the driver according to the comparison, wherein the means for influencing the steering assistance includes a means for displacing the zero point of the characteristic curve of the steering assistance according to the comparison.

24. Driver-assist system according to claim 23, wherein the driver-assist system includes:
means for determining a theoretical path or a theoretical path angle on the basis of the detected or estimated road course,
means for determining the actual path and an actual path angle on the basis of the detected or estimated vehicle course, a comparison means for comparing the theoretical path and the theoretical path angle with the actual path and the actual path angle, wherein the means for displacing the zero point shall displace the zero point of the characteristic curve for steering assistance according to said comparison.
